(19) United States
(12) Patent Application Publication
(10) Pub. No.: US 2009/0193104 A1
(43) Pub. Date: Jul. 30, 2009

(54) FORWARDING OF DEVICE ABSENCE INFORMATION IN SYSTEM WITH A DYNAMICALLY CHANGING SET OF DEVICES

(75) Inventors: Benjamin James Gras, Amsterdam (NL); Maarten Peter Bodlaender, Eindhoven (NL); Jarno Guidi, Bologna (IT); Martinus Richardus Van Steen, Amsterdam (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,053

(22) PCT Filed: Oct. 14, 2005
(86) PCT No.: PCT/IB05/53377

§ 371 Date: Apr. 11, 2007

(30) Foreign Application Priority Data
Oct. 19, 2004 (EP) 04105144.2

(51) Int. Cl. G06F 15/173

(52) U.S. Cl. 709/223

(57) ABSTRACT

A suspension member for connecting a vehicle body and a suspension device that comprises a pair of side members that extend in the longitudinal direction of the vehicle body and are located symmetrically relative to the center in the transverse direction of the vehicle body, and cross members interconnecting the pair of side members and extending in the transverse direction of the vehicle body. The suspension member is formed by press molding only after flat plate-like side members and cross members are welded in butt joints.

The invention relates to an information exchanging system that comprises a dynamically changing set of devices, to a method of operating such a system and to devices for such a system.

A paper submitted at the IEEE CCNC conference 2004 (Las Vegas), titled “Enhancing Discovery with Liveness” by Maarten Bodlaender, Jarno Guidi and Lex Heerink describes a system with a dynamically changing set of devices. Examples of such a system occur in home and office environments where there are many devices such as television sets, printers, storage devices, remote controls, portable information access devices such as media players, palmtop computers etc. These types of devices may be connected by wired and/or wireless networks, to form a system wherein the different devices can communicate with each other. Devices can become active in such a system when they are plugged into the system, or carried into an area covered by the wireless connection, or when they are switched on. Conversely the devices can be deactivated by switching off power, carrying the devices away or by unplugging the devices from the system.

For optimal operation of such a variable system it is desirable that the devices have up to date information about other devices that are available in the system, in particular about other devices that may be used as a server to perform remote functions. Collection of this presence information is performed by sending probe messages to detect the presence of devices. Preferably, presence information should be collected in a distributed way, by more than one device, to ensure robustness against removal of an information collecting device from the system.

The CCNC conference paper proposes a solution to this problem that makes use of a so-called “liveness ping protocol” and a “proxy-bye protocol”. The paper distinguishes two types of devices: clients and servers. Servers are devices that are able to perform functions at the commands of clients. Hence, from the liveness protocol perspective, clients are interested in knowing about the availability of servers. According to the “liveness ping protocol” each client sends ping messages (messages that request sending of a return message to confirm its presence) to a server about which the client wants updated presence information. In response the server, if present, returns a ping response message to the client. When the client has not received a ping response message in reply to a ping message within a predetermined timeout interval, the client sends a new ping message. This is repeated a predetermined number of times until the client decides that the server is not actively present and updates its presence information accordingly.

One potential problem with this type of “liveness ping protocol” is that it may create considerable network bandwidth occupation and server load if there are many clients that attempt to keep their presence information about the same server highly up to date.

The CCNC conference paper addresses this problem by combining the liveness protocol with the proxy bye protocol. In the ping response message the server includes the network addresses of the last two previous clients that have sent ping messages to the server. The client that receives the ping response message stores these network addresses. Later, when the client decides that the server is no longer connected, the client notifies the clients whose network addresses it has from an earlier ping response. These clients forward the notification to the clients for which they store network addresses and so on. In this way, information about absence of a server will spread quickly, even if none of the clients sends ping messages at a high frequency.

In this proxy bye protocol the clients notify each other by means of a forwarding mechanism: each client forwards the proxy bye message to a couple of other clients. To apply the proxy bye protocol, the clients of a server need to have a list of forwarding addresses of other clients of that server that they must notify when it is detected that the server is no longer actively connected. The server stores the addresses of two clients from which it has most recently received ping messages and sends these addresses to a client in the response to a next ping message. Thus, these addresses are distributed by the server. The client device stores the addresses in a list of two forwarding addresses. Later, the client uses the addresses from the list to forward the proxy bye message once it is detected that the server is no longer actively present in the system.

There is a risk that clients have become inactive by the time of the proxy bye message. As a result forwarding of proxy bye messages may be hampered. To reduce this effect the server provides the address of each client to more than one client (e.g. two clients) for forwarding. However, if all the other clients that have a particular clients' address are inactive at the time of the proxy bye message, the particular client will discover the absence of the server only when the particular client sends a ping message. This may take a long time if the frequency with which the client sends ping messages to the server has been adapted to a low value, in the case that there are many active clients.

Also, just after a new client device has joined, there will be no client devices that have the new client device on their list of forwarding addresses. When the server leaves the system at this time, the new client device may fail to receive any proxy bye messages, so that it will discover the departure of the server only when it sends a new ping message.

The CCNC conference paper addresses this problem by imposing a limit on the maximum time that will elapse before a client device will discover the departure of the server. Thus a minimum is imposed on the frequency with which any client sends ping messages. This avoids long delays, but it has the disadvantage that the combined frequency at which ping messages from all clients arrive at the server can rise without bound if more and more clients are added to the system.

Furthermore, it has been found that the liveness protocol has the tendency to cause some clients to send ping messages at a high frequency and others to send ping messages at a low frequency. The reason for this is as follows. According to the CCNC conference paper, the frequency at which an individual client device sends ping messages is selected by the individual client device on the basis of a count of the number of client devices that have sent ping messages between two ping messages of the individual client device. This count, divided by the duration of the time interval between the successive ping messages from the individual client device, represents the overall frequency at which ping messages are sent to the server device. The individual client device adapts its frequency to keep the overall frequency below a maximum value. However, when a client device does not receive a message from the server device for a long time, the frequency of the client device may become outdated, for example if many client devices are added, or leave the system. This increases the risk that information of departure of the server device will not be forwarded when many client devices leave the system later on.

Among others, it is an object of the invention to limit the delay between deactivation of a server and notification of deactivation of the server without having to increase the overall frequency of detection messages significantly when the number of client devices increases.

Among others, it is an object of the invention to reduce the risk that a client device does not receive notice even if no lower limit is imposed on the frequency at which individual client devices send ping messages (detection messages to detect the server).

Among others, it is an object of the invention to improve the balance between the lengths of the paths along which proxy bye messages reach different client devices.

Among others, it is an object of the invention to improve the balance between the frequencies at which client devices send ping messages.

In the method and system according to the invention at least one client device of a server device sends update messages to fellow client devices of the server device to update their lists of forwarding addresses. That is, in contrast to the CCNC conference paper, not just the server, but at least one of the client devices also supplies addresses to add to the forwarding lists. Preferably a plurality or even all of the client devices do so. Preferably, the client devices send update messages to addresses of client devices that have been indicated by a server device to be addresses of client devices of that server device (because these client devices have sent detection messages (ping messages) to the server device). Preferably, a client device that receives an update message adds the source address of the update message to its list of forwarding addresses. In this way no further addresses need to be included in the update messages, but alternatively the update message may include other addresses that may be added to the list.

Preferably, the client devices that use the update messages to update their lists of forwarding addresses also send detection messages (ping messages) to the server device from time to time. Thus, if such a client device detects that the server device is no longer actively present, the client device is able to use an updated list to start distribution of the information that the server device is no longer actively present. However as an alternative, without deviating from the invention, some of the client devices that use the update messages to update lists of forwarding addresses may not send detection messages at all, using the list only for forwarding. This may be used to reduce the overall frequency of detection messages.

Preferably, a client device sends a detection message to the server device in response to detection that none of the fellow clients of the client device respond to the update messages. In this way, on one hand the frequency of detection messages to the server device is normally kept low. On the other hand the delay is reduced before the client device detects that the server device is no longer active, even if no devices forward messages to the client device.

Because the client devices of a server device communicate among each other to update the lists to reduce the risk that no forwarding occurs to all client devices, it is not necessary to impose a lower limit on the average frequency at which an individual client device sends detection messages to the server device. These individual frequencies may be adapted freely to the number of client devices of the server.

In an embodiment, an update message, and/or messages that are exchanged between client devices of a server device in response to the update message, contain information about frequency control data that a client device uses to control the average frequency at which it sends detection messages to the server device. This information may be used to adjust the frequency control data of the client devices that exchange the update messages. Preferably, the difference between the selected average frequencies of the client devices that exchange an update message is reduced.

In an embodiment, the client devices that exchange an update message mutually adjust their average frequencies so that a sum of their average frequencies remains the unaltered. The sum determines how much the client devices contribute to the overall frequency at which the server device receives detection messages. When the sum is kept constant during exchanges between client devices, the server device has control over the overall frequency of detection messages from its collection of client devices, by feeding information to individual client devices to alter the frequency of individual client devices.

The average frequency at which a client device sends detection messages to a server device may be realized for example by selecting a random time point for transmission of the detection message, so that the probability that a time point is selected is controlled by the frequency control data. For example, the frequency control data determines the duration of a time interval from which the time point is selected.

In a further embodiment the client devices maintain expiry information for respective addresses in the list of forwarding addresses. In this way the client devices are able to remove an address from the list if the expiry information indicates that no confirmation of active presence of a client device at the address has been received for a predetermined time interval.

These and other objects and advantageous aspects of the invention will be described in more detail by means of non-limiting examples using the following Figures.

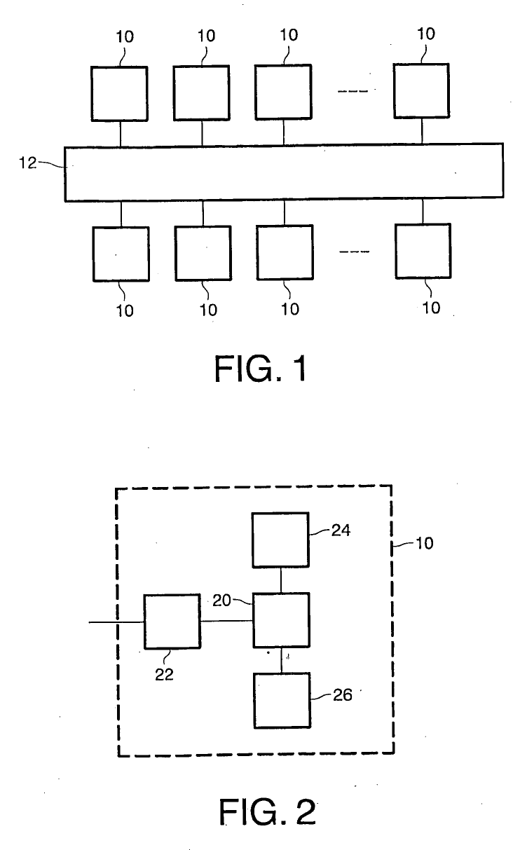

FIG. 1 shows a system with a plurality of devices

FIG. 2 shows a device for use in the system

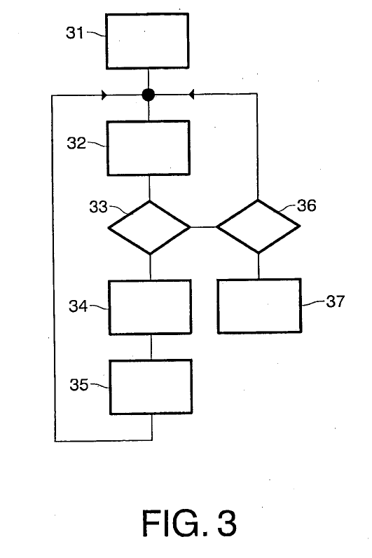

FIG. 3 shows a flow chart of an operation of a client

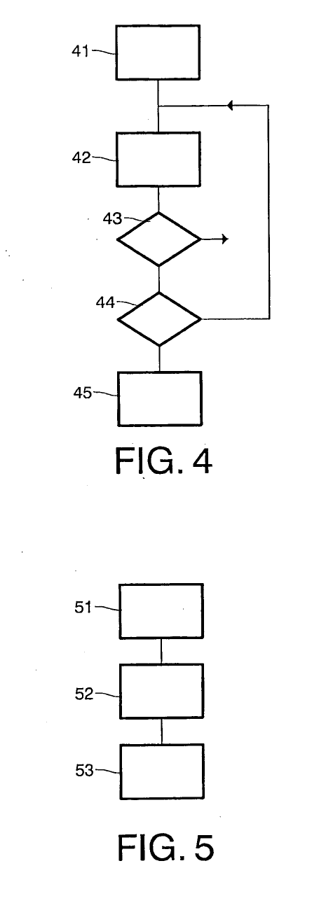

FIG. 4 shows a flow chart for receiving a proxy-bye message.

FIG. 5 shown a flow chart for receiving a ping message.

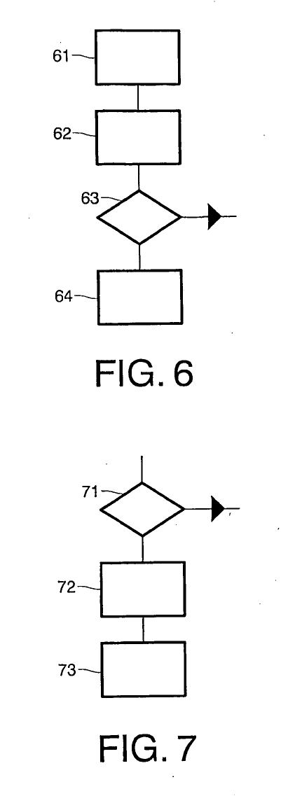

FIGS. 6 and 7 show flow-charts to maintain a list of forwarding addresses

FIG. 1 shows a system containing a plurality of devices 10 interconnected by a communication medium 12. Communication medium 12 can be a wired communication network for example or a wireless communication network or a combination of both. Devices 10 can enter and leave the system dynamically, for example by switching selected devices on or off, attaching devices 10 to medium 12 or detaching devices 10 from medium, or by moving wireless devices 10 into or out of a reception range.

Devices 10 include for example handheld remote control devices, television sets, audio/video storage devices, portable audio/video players, personal computing devices etc. In an office environment devices 10 may include printers, storage devices, personal computers, portable computers, laptops, palmtops, scanners etc. Although a small number of devices 10 is shown by way of example it should be understood that in practical systems many more clients may be present.

FIG. 2 shows a device 10. The device 10 contains a processor 20 coupled to a network interface 22, a clock circuit 24 and a memory 26. Processor 20 is typically a programmable processor, programmed with a program that causes processor 20 to perform the operations described in the following. However, as an alternative a dedicated logic circuit may be used, designed to perform these operations.

In operation devices 10, when active, determine which type of services they may need to request. Devices 10 that may require a service will be called “clients”. Devices 10 that are able to perform these services will be called “servers”.

An example of a client is for example a laptop computer that is a client of a file server service provided by storage devices, the laptop computer keeping a list of available storage devices. A handheld remote control device, as another example, may be a client that maintains the addresses of servers like a television set and/or a video/audio storage device that are within reach to perform commands entered in the remote control device. As yet another example a portable audio and or video rendering device may be a client of a nearby storage device for audio/video content.

Each client 10 maintains a list of addresses of one or more active servers 10. It may be noted that a device 10 may be a client and a server at the same time for different services. Likewise a device 10 may be a client of more than one type of service and/or a server for more than one type of service.

FIG. 3 shows a flow chart of a process executed by a client. In a first step 31 processor 20 of a client records (e.g. in memory 26) the address of a server 10 that is able to perform a service that the client 10 may need, after “discovering” the active presence of the server 10 in the system. This discovery process is not the subject of the present invention. Many solutions exist, involving for example sending a multicast message from the client 10 generally addressed to all servers of a certain type and receiving back responses and/or receiving multicast messages, which are sent by servers when they become an active part of the network and/or periodically, generally addressed to all clients of a certain service.

Subsequent steps of the flow-chart are used to the list of discovered clients up to date. In a second step 32 processor 20 of client 10 causes interface 22 to send a “ping message” addressed to a server from the list. The term “ping” is a conventional-term in the art, used to refer to a message with no other purpose that eliciting a response. In a third step 33 processor 20 tests whether a ping response message has been received in reply to the ping message within a predetermined response time interval. If so, processor 20 proceeds to a fourth step 34 wherein processor extracts a representation of a time point T and addresses of fellow clients from the ping response message and records this information in memory 26. Next, in a fifth step 35 processor 20 waits until clock circuit 24 indicates that the specified time point T has been reached. The time point T is preferably specified by means of a delay count Q of clock pulses that must be counted before the next ping message can be sent. When the time to send the next ping message has arrived processor 20 returns to the second step 32.

If processor 20 does not detect a ping reply message within the response time interval in second step 32, processor 20 executes a sixth step 36, returning to second step 32 if no more than a predetermined successive ping messages have not resulted in a ping response message. When more than the predetermined successive ping messages has not resulted in a ping response message, processor 20 executes a seventh step 37. It will be appreciated that the return to the second step 32 after a failure to receive a ping response message is merely a safety measure for the case that there is a significant risk that ping messages and/or ping response messages get lost. The greater the risk, the more returns to second step 32 are used preferably. If there is no significant risk of this seventh step 37 may be executed immediately.

In seventh step 37 processor 20 removes the server address from its list of actively present servers and sends “proxy bye messages” to the addresses of the fellow clients that have been indicated in a last received ping response message, if any from the server. In the proxy-bye message, the client 10 includes the server address to notify the fellow clients that no ping response message was received from the server with that server address. Preferably, the client 10 also adds information about the time at which was expected to check the device by means of a ping message. This information enables other clients to detect if current proxy bye message is old with respect of previously received proxy bye messages and/or with respect to other clients' ping messages.

FIG. 4 shows a flow chart of a process executed by a client when it receives a proxy-bye message. In a first step 41 processor 20 detects the proxy-bye message for a server. If the server is still listed as an active server in the client 10, processor 20 executes a second step 42 sending a ping message to the server.

In a third step 43 the processor 20 detects whether a ping response message is received. If so, the process terminates. If not processor executes a fourth step 44, repeating from second step 32 if no more than a predetermined number of ping messages have been sent. If more than the predetermined number of ping messages has been sent processor 20 executes fifth step 45, which is similar to seventh step 37 of FIG. 3, removing the server address from its list of actively present servers and sending “proxy bye messages” to the addresses of the fellow clients that have been indicated in a last received ping response message, if any.

Several further steps may be added. For example, client 10 preferably checks whether the proxy bye message was already received. If so, client 10 discards the message and terminates the process of the flow-chart. Furthermore, the proxy bye message may contain information about the time when the client that has sent the proxy-bye was expected to execute the ping action. Based on this information, client 10 may check whether a more recent ping action was successfully completed. If so, then the proxy bye message carries outdated information, in which case client 10 discards the message.

It will be appreciated that the second step 42 is merely a precaution against erroneous or even intentionally faked proxy bye messages. When there is no significant risk of such messages, second step 42 may be skipped, the process moving from the first to the fifth step immediately. Similarly, the return to the second step 42 after a failure to receive a ping response message is merely a safety measure for the case that there is a significant risk that ping messages and/or ping response messages get lost. The greater the risk, the more returns to second step 42 are used preferably. If there is no significant risk the fourth step may be skipped.

FIG. 5 shown a flow chart of a process executed by a server when it receives a ping message. In a first step 51 processor 20 of the server detects the ping message and records the address of the sender of the ping message in memory 26; in principle only a predetermined number of sender addresses from most recently received ping messages need be kept.

In a second step 52 processor 20 causes interface 22 to send a ping response message to the address of the client that has sent the ping message that was detected in first step 51. Processor 20 includes the addresses of a number of other clients that have last sent ping messages in the ping response message. The addresses are included for example at respective predetermined bit distances from the start of the ping response message, or preceded by labels, so that the client will be able to extract this information from the ping response message.

FIGS. 6 and 7 show flow-charts of processes executed by the client devices to maintain the list of forwarding addresses so as to increase the probability that the clients will receive proxy bye messages from other clients. In these processes client devices of a server device update the list of forwarding addresses. For this purpose the client devices exchange messages among each other at a higher frequency than each client device sends messages to the server device.

FIG. 6 shows a flow-chart of a process that is executed by a particular client device to send update messages to fellow client devices. In a first step 61 of the flow-chart processor 20 of the particular client device causes network interface 22 to transmit update messages with respective destination addresses from the list of forwarding addresses (i.e. to fellow client devices). In a first embodiment update messages are sent only to addresses that the client device has received directly from the server device. This ensures that update message are sent that are known to have been recently active. Alternatively, update messages may be sent to all addresses of the list. In a second step 62 processor 20 waits a predetermined time-interval for reply messages in response to the update messages, and records from which fellow client devices reply messages are received. Of course, first and second step may also be executed repeatedly each time for one or more addresses. In a third step 63 processor 20 tests whether at least one reply message has been received in the predetermined time interval. If so, the flow-chart terminates. If not, processor 20 executes a fourth step 64, performing the ping process described with respect to FIG. 3.

FIG. 7 shows a flow-chart of a process that is executed by a particular client device when it receives an update message. In a first step 71 processor 20 tests whether an update message has been received. If not, the flow chart terminates. If an update message has been received, processor 20 executes a second step 72, transmitting a reply message to the update message to the client device that has sent the update message. Subsequently processor 20 executes a third step 73 in which processor 20 adds the address of the sender of the update message to its list of forwarding addresses in memory 26, if this address is not already in its list of forwarding addresses.

One important aspect of processes disclosed in FIGS. 6 and 7 is that no communication with the server device is normally required for the exchange of the update message. Preferably, the average frequency with which a client device executes the process of FIG. 6 is substantially fixed, while the average frequency with which this client device sends ping messages to the server device is adapted to the number of client devices. This is particularly advantageous if the communication medium 12 is sectioned, so that messages between client devices do not occupy bandwidth over the entire communication medium 12, but leave room for simultaneous exchange of other messages in other sections of the communication medium, for example in a section to which the server device is coupled.

However, without deviating from the invention, the average frequency of sending update messages may be adapted as well, for example so that an average amount of occupation of the sections remains below a predetermined value. Typically, the ratio between the frequency with which a client device sends update messages and the frequency with which the client device sends ping messages to a server device increases when the number of client devices of the server device grows. In the extreme, when the number of client devices is so small that the frequency of update messages falls below the frequency of ping messages, the update messages may be suppressed altogether.

Preferably the frequency of transmission of ping messages by a client device may be adapted without lower bound when the number of client devices that needs to know about the server device increases, so that the average frequency with which the server device receives ping messages remains below a predetermined maximum. The processes illustrated with FIGS. 6 and 7 ensure that in this case the probability is reduced that a client device will discover that a server device is no longer actively present only when the client device attempts to use the service provided by the client device or when the client sends a ping message to the client device.

The average frequency of transmission of ping messages may be controlled by frequency control data in memory 26, which is read by processing circuit 20 to determine when to send ping messages. Processing circuit 20 may adapt the frequency of the ping messages and the update messages for example by sending these messages periodically, each time after a time interval that is selected dependent on a desired average frequency represented by the frequency control data, or by sending these messages each time after a time interval that has been selected at random within a time interval that is determined by the desired average frequency represented by the frequency control data. Alternatively, a client device may select a random number for each time point and transmit a detection message if this random number is above a threshold that is determined from the desired frequency. Of course other ways may be selected to ensure that the random probability that a time point is selected is controlled by the desired frequency. The random selection has the advantage over the periodic selection that it avoids distributions of ping messages with strong peaks as a function of time, due to simultaneous switch on of many client devices.

The frequency control data is preferably adapted so that the ping message frequencies are equalized as a result of an interaction between the client devices. This equalization affords a better control over the average frequency of ping messages, but it also ensures that addresses of different client devices will be distributed more equally among the lists of forwarding addresses in the different client devices.

Preferably, in first step 61, the processing circuit includes information in the update messages that is indicative of the desired average frequency of sending ping messages. For example, processor 20 may insert information in the update message that represents a duration of the time interval that it proposes to use between successive ping messages (or within which it proposes to select at random a time to transmit a ping message). In response the processor 20 of the receiving client device may set frequency control data in its memory 26 that controls its required frequency for sending ping messages, so that the frequency becomes an average of a previously selected frequency and the frequency represented in the update message.

Preferably the processor 20 of the receiving client device may include information in the reply message to allow the processor 20 of the client device that has sent the update message to update its ping frequency accordingly. Information that represents the average frequency may be included in the reply message for example.

Preferably, the client devices average the frequencies at which they send ping messages to the server device. A first and a second client device store frequency control data that represent a first and second average frequency f1, f2 respectively. The represented average frequencies determine the average frequencies at which the client devices send ping messages to the server device. When the first client device and the second client device exchange an update message and a reply, the frequencies f1, f2 may be adapted to frequencies f1′ and f2′ according to

f1′=w1*f1+(1−w2)*f2

f2′=w2*f2+(1−w1)*f1

Herein, w1 and w2 are weight coefficients. The effect of this type of adaptation is that the frequency with which ping messages arrive at the server device is not effected, because f1+f2=f1′+f2′. In a preferred embodiment the weight coefficients w1, w2 are equal to ½, but other weights may be used, for example closer to 1, so that the frequencies are less sensitive to sudden changes.

When a client device exchanges a ping message and a ping response with the server device, the server device provides information to adjust the frequency f1 or f2 represented by the frequency control data that is stored in the client device. Thus, the server device controls the sum of the average frequencies of the client devices, i.e. the overall frequency at which the server device receives ping messages. The system is preferably arranged so that this overall frequency is kept below a predetermined maximum that can be handled by the server device.

In one embodiment, the server transmits “pingcount” information in response to ping messages, the pingcount representing the overall number of received ping messages received since a certain time point. In this embodiment, a client device compares the pingcounts represented in response to its successive ping messages and relates the difference to the duration of the time interval between the ping messages, to determine whether the overall frequency of ping messages is too high or too low. In response, the client device will lower or raise its frequency (and thereby the overall frequency) of sending ping messages. Subsequently, update messages between client devices will allow this adjustment to diffuse over the client devices.

In another embodiment, the server device itself is arranged to compare an average frequency with which it receives ping messages with a desired frequency. In this embodiment the server device sends commands to increase or decrease the frequency to client devices dependent on whether the observed frequency is above or below a desired value. Subsequently, update messages between client devices will allow this adjustment to diffuse over the client devices. This control by the server device has the advantage that an estimate of the overall frequency during a recent time interval may be used to select whether to increase or decrease the frequencies. Thus, a more rapid response to variations in the number of client devices is possible.

Instead of averaging the frequencies, the client devices may average the durations of the time intervals between successive ping messages. However, this has the disadvantage that it affects the overall frequency with which ping messages arrive at the server device.

Although a particular mechanism for setting the average frequency of ping messages has been described, it will be appreciated that according to one aspect the invention may be used separate from the setting of the frequency, merely to update the lists of forwarding addresses.

Preferably, the client device is arranged to reserve a predetermined amount of memory space for the list of forwarding addresses, so that the list contains at most a predetermined number of client addresses to which proxy-bye messages will be sent. In this case, processor may need to remove addresses from the list when third step 63 is executed. The oldest addresses may be selected for removal for example.

Preferably, processor 20 also stores expiry information for the addresses in the list in memory 26. When the processor 20 detects an update message from the client device with a specific address, the processor 20 updates the expiry information for that address. Similarly, when the processor 20 receives a reply to an update message from the client device with the specific address, the processor 20 updates the expiry information for that address. When an address has expired processor 20 removes the address from the list. The expiry information may take the form of a clock count value of local clock circuit 24. This value may be updated for example when the address is received from the server device and/or when the client device that stores the address successfully exchanges a message with the client device with the address. In this case, processor 20 may remove an address from the list of forwarding addresses once the clock count from local clock circuit 24 exceeds the stored count for the address by a predetermined amount. However, alternative mechanisms are possible, such as storage of a clock count value that must be reached before the address may be discarded.

In an embodiment, the server device is arranged to send expiry information in combination with addresses to which proxy-bye messages must be sent. In this embodiment the client device stores the expiry information for the addresses that it receives from the server device and discards the addresses if the information has expired.

Preferably, a client device is arranged to transmit update messages to its fellow clients within a predetermined initial time interval, after it has sent a first ping message and received a ping response. This increases the probability that a newly added client device will receive forwarded messages if the server device ceases to be actively connected to the system soon after. The predetermined initial time interval is preferably shorter than the time interval used between subsequent update messages.

It should be appreciated that the invention is not limited to the embodiments that have been shown. For example, although a client/server architecture has been shown that contains a programmable processor that is programmed to perform the actions described with reference to the flow-charts, it should be appreciated that instead part or all of the devices may contain dedicated circuits that are specifically designed to perform these actions.

Furthermore, although preferably all client devices send the update messages, this is not always necessary. For example, in certain situations the main risk is that client devices will not receive a proxy bye message if they have recently send their first ping message to the server device. In these situations it suffices that client devices send update messages only initially after sending their first ping message. In this way the risk is reduced that these client devices will receive no proxy bye messages.

In other situations the main risk is that the forwarding of a proxy bye message does not cause the proxy bye message to reach all client devices when some client devices that should have forwarded this proxy bye message are no longer active. In these situations it is particularly advantageous that a client sends a ping message to the server device if it does not receive a reply to its update messages from fellow client devices on the list of forwarding addresses. In this way the client device is able to get fresh addresses for its list.

In these situations it is also advantageous that the a group of client devices that have the address of another client device on their list of forwarding addresses send update messages to that other device, so that the other device is enabled to send later update messages to the group of client devices. In this way the other client device is able to detect when it is at risk of not receiving forwarded proxy bye messages. In response the other client device may send a ping message to obtain up to date information about the server device and to facilitate that the other client device is placed on the forwarding lists of other client devices.

However, advantages are realized even if no ping message is sent in this case, since the exchange of forwarding addresses for forwarding proxy bye messages between active client devices reduces the risk that forwarding will fail when only addresses of client device are available that are no longer active.

Although preferably the client devices send the update messages to the addresses that have been supplied by the server device for use to forward proxy bye messages, it will be understood that other addresses of known or potential fellow clients may be used instead, or in addition. For example, the server device may be arranged to supply addresses for sending update messages which need not initially be used for sending proxy bye messages. The advantage of using addresses that are supplied by the server device after the server device has received ping messages from these addresses is that the addresses will address active client devices with a high probability. The advantage of using the same addresses both for update messages and proxy bye messages is that only a single type of address need be used.

Furthermore, although in the embodiments that have been described the update message contains one address (the source address of the update message) that is stored in the list of forwarding addresses of the client device that receives the update message, it should be understood that a client may be arranged to include other addresses in the update message, for example addresses from the list of forwarding addresses of the client device that sends the update message. In this case, the client device that receives the update message may be arranged to add these other addresses to its list of forwarding addresses in addition to the source address, or instead of the source address. This makes it possible to update the lists more quickly. However, using only the source address has the advantage that a shorter message suffices and also that the lists do not overflow quickly, or that addresses from the lists have to be replaced at a high rate.

Although the invention has been described using a single server device, it should be appreciated that in practice many different server devices may be actively connected to the system. In this case, a client device may maintain respective lists of forwarding addresses for each server that the client device may want to use and the client device establishes ping message frequencies for sending ping messages to each of the server devices.

1. A system that comprises a communication medium (12) and a dynamically changeable set of devices (10) connected via the communication medium (12), the devices (10) comprising
a server device (10) coupled to the medium (12) and arranged to receive detection messages from the medium (12) and to send responses to the detection messages through the medium (12);
a first client device (10) of the server device (10) coupled to the medium (12) and comprising a memory (26) for storing a list of forwarding addresses of fellow client devices (10), the client device (10) being arranged to send absence report messages to the addresses from the list in response to a detection that the server device (10) does not respond to a detection message and/or in response to reception of a further absence report message;
a second client device (10) coupled to the medium (12) and arranged to receive an address of the first client device (10) from the server device (10) and to send an update message to the first client device (10) using the received address, the first client device being arranged to respond to the update message by adding an address from the update message to its list of forwarding addresses.

2. A system according to claim 1, wherein the first client device (10) is arranged to extract a source address of the second client device (10) from the update message and to place the extracted address on its list of forwarding addresses.

3. A system according to claim 1, wherein the second client device (10), like the first client device (10), comprises a memory (26) for storing a list of forwarding addresses of fellow client devices, the second client device (10) being arranged to send absence report messages to the addresses from the list in response to a detection that the server device (10) does not respond to a detection message and/or in response to reception of a further absence report message; the second client device (10) being arranged to select a destination address for the update message from its list of forwarding addresses.

4. A system according to claim 3, wherein the first and second client device (10) are arranged to send detection messages to the server device (10).

5. A system according to claim 4, wherein the first and second client device (10) are arranged to store frequency control data, the client devices (10) each being arranged to control an average frequency of sending detection messages to the server device (10) dependent on their respective frequency control data, the first and second client device (10) being arranged to exchange information about their respective frequency control data as part of an exchange that is triggered by the update message; and to adjust the frequency control data in the first and second client device (10) so that a difference between the respective average frequencies is reduced.

6. A system according to claim 5, wherein the client devices (10) are arranged to adjust the frequency control data so that a sum of the respective average frequencies of the first and second client devices does not change.

7. A system according to claim 5, wherein the first and the second client device (10) are arranged to adjust the frequency control data so that the respective average frequencies are changed to an average of their preceding values.

8. A system according to claim 1, wherein the first client device (10) is arranged to maintain expiry information for respective addresses in the list of forwarding addresses, and to remove an address from the list if the expiry information indicates that no confirmation of active presence of a client device (10) at the address has been received for a predetermined time interval.

9. A system according to claim 1, wherein the second client device (10) is arranged to respond to detection that no reply to the update message is received, by sending a detection message to the server device (10).

10. A system according to claim 1, wherein the second client device (10) is arranged to store frequency control data and send the detection messages at time points that the second client device selects with a random or pseudo-random probability that is controlled by the frequency control data.

11. A client device for use in a system that comprises a communication medium (12) and a dynamically changeable set of devices (10) connected to the communication medium (12), the client device (10) having a memory (26) for storing a list of forwarding addresses of fellow client devices of the server device (10), the client device being arranged to send a detection message to the server device (10) via the medium (12), the client device being arranged to send absence report messages via the medium (12) to the addresses from the list in response to detection that the server device (10) does not respond to a detection message and/or in response to reception of a further absence report message; the client device being arranged to receive an address of a fellow client device from the server device (10), to add the address to the list and to send an update message to the fellow client device for expanding a further list of forwarding addresses in the fellow client device.

12. A client device according to claim 11, arranged to store frequency control data, the client device being arranged to control an average frequency of sending detection messages to the server device (10) dependent on the respective frequency control data, the client device being arranged to exchange information about the frequency control data from the fellow client device as part of an exchange that is triggered by the update message; and to use the information to adjust the frequency control data so that a difference between the average frequencies of the client device and the fellow client device is reduced.

13. A client device according to claim 11, arranged to respond to detection that no reply to the update message is received, by sending a detection message to the server device.

14. A client device according to claim 11, arranged to store frequency control data and send the detection messages at time points that are selected at a random probability that is controlled by the frequency control data.

15. A client device for use in a system that comprises a communication medium ((12) and a dynamically changeable set of devices (10) connected to the communication medium (12), the client device having a memory (26) for storing a list of forwarding addresses of fellow client devices (10), the client device being arranged to send absence report messages to the addresses from the list, in response to detection that the server device (10) does not respond to a detection message and/or in response to reception of a further absence report message; the client device being arranged to receive an update message from a fellow client device and to respond to the update message by adding an address from the update message to its list of forwarding addresses.

16. A client device according to claim 15, arranged to extract a source address of the fellow client device from the update message and to place the extracted address on its list of forwarding devices.

17. A client device according to claim 15, arranged to store frequency control data, and to control an average frequency of sending detection messages to the server device (10) dependent on the frequency control data, the client device being arranged to exchange information about the frequency control data with the fellow client device (10) as part of an exchange that is triggered by the update message; and to make an adjustment of the frequency control data so that a difference between the respective average frequencies of the client device and the fellow client device (10) is reduced.

18. A client device according to claim 15, arranged to maintain expiry information for respective addresses in the list of forwarding addresses, and to remove an address from the list if the expiry information indicates that no confirmation of active presence of a client device at the address has been received for a predetermined time interval.

19. A method of operating a system that comprises a dynamically changing set of devices (10), wherein an absence report message, which reports the lack of active presence of a server device (10), is forwarded by client devices (10) of the server device (10) to other client devices of the server device (10), when the server device does not respond to a detection message, the method comprising:
maintaining respective lists of forwarding addresses in respective client devices (10) for use as destination addresses when forwarding the absence report message;
using the server device (10) to supply an address of a fellow client device (10) at least to a first client device (10);
using the first client device (10) to send an update message to the supplied address of the fellow client device (10);
updating the list of forwarding addresses in the fellow client device (10) on the basis of information from the update message.

20. A method according to claim 19, wherein the fellow client device (10) uses a source address of the update message to place an address of the first client device (10) on its list of forwarding devices.

21. A method according to claim 19, comprising:
sending detection messages from the first client device (10) and the fellow client device (10) to the server device;
storing, in the first client device (10) and the fellow client device (10), frequency control data that controls respective average frequencies at which the first client device (10) and the fellow client device (10) send the update messages respectively;
exchanging information about the frequency control data as part of an exchange that is triggered by the update message;
adjusting the frequency control data in the first client device (10) and the fellow client device (10) so that a difference between the respective average frequencies is reduced.

22. A method according to claim 21, wherein said adjusting of the control data is performed so that a sum of the respective average frequencies does not change.

23. A method according to claim 21, wherein said adjusting of the control data is performed so that the respective average frequencies are changed to an average of their preceding values.

24. A method according to claim 21, wherein
the server device (10) collects information that is indicative of an overall frequency at which the client devices (10) send detection messages to the server device (10);
the server device (10) supplies the information to the first client device (10) and/or the fellow client devices (10);
the first client device (10) and/or the fellow client devices (10) adjust their average frequencies in response to the information so that the overall frequency is changed towards a predetermined value.

25. A method according to claim 19, comprising sending a detection message from the first client device (10) to the server device (10), to detect whether the server device (10) is still actively present, the server device (10) supplying the address of the fellow client device (10) in a response to the detection message, the first client device (10) sending the absence report message to the addresses on its list of forwarding addresses if the first client device (10) detects no response to the detection message.

26. A method according to claim 19, comprising sending a detection message from the first client device (10) to the server device (10) in response to detection that no reply to the update message is received.

27. A method according to claim 19, the method comprising
maintaining expiry information for respective addresses in the list of forwarding addresses,
removing an address from the list if the expiry information indicates that no confirmation of active presence of a client device (10) at the address has been received for a predetermined time interval.

28. A computer program product, containing instructions which, when executed by a programmable client device cause the client device to perform as a client device according to claim 11.
